(19) United States
(12) Patent Application Publication
(10) Pub. No.: US 2003/0159572 A1
(43) Pub. Date: Aug. 28, 2003

(54) Method and apparatus of immobilizing an unauthorized intruder to a secure area

(76) Inventor: Richard Downs JR., Arlington, VA (US)

Correspondence Address: Karl F. Milde, Jr., Esq., MILDE & HOFFBERG, LLP, Suite 460, 10 Bank Street, White Plains, NY, 10606, US

(21) Appl. No.: 10/084,692

(22) Filed: Feb. 27, 2002

(51) Int. Cl. B64D 1/04; F41F 5/00

(52) U.S. Cl. 89/1.11

(57) ABSTRACT

A system is disclosed for immobilizing an unauthorized intruder to a secure area. A plurality of immobilizing devices, capable of propelling a non-lethal projectile through space, are installed in the region of the secure area. A remote control device is used for selecting and deploying the immobilizing device, in response to the presence of an unauthorized intruder in the region of the secure area, to at least temporarily incapacitate the intruder. The intruder is thus rendered harmless until security personnel are able to take control.

### BACKGROUND OF THE INVENTION

The present invention relates to a method and apparatus for immobilizing an unauthorized intruder in the region of a secure area, such as the flight deck or cockpit of an aircraft, the captain's bridge of a ship or sea-going vessel, the engineer's cabin of a train, the driver's seat of a truck or bus, or a secure building or area within or without a building.

As is well known, terrorists and hijackers sometimes attempt to assume control of a transport vehicle, such as an aircraft, ship, train, truck or bus, or of a building, or other areas, by terrorizing and intimidating the persons in the vicinity. Once the attacker (terrorist or hijacker) takes control of a vehicle or building, for example, he or she may cause great loss of life and/or property damage by illegal and immoral acts such as firing weapons and/or causing the vehicle to crash.

Particularly when the attacker (hereinafter “unauthorized intruder”) is aboard a moving vehicle, attempts to subdue him or her may result in collateral damage, such as injury or death to living beings or damage to the vehicle and/or surrounding environment. For example, if an attempt is made to physically subdue the unauthorized intruder by conventional weapons, such as guns or grenades, a stray bullet or an explosion may result in collateral damage, such as injuring or killing one or more innocent persons, and/or they may lead to a crash of the moving vehicle, which in itself would result in loss of life and property damage.

### SUMMARY OF THE INVENTION

It is a principal object of the present invention to provide a system (method and apparatus) for neutralizing an attacker—that is, an unauthorized intruder—in the region of a secure area in a way which will minimize collateral damage to living beings and to the surrounding environment.

This object, as well as other objects which will become apparent from the discussion that follows, are achieved, in accordance with the present invention, by immobilizing the unauthorized intruder by remote control with an element of surprise. In particular, the method comprises the steps of:

(a) installing a plurality of immobilizing devices, capable of propelling a projectile through space, in the region of the secure area;

(b) monitoring the region of the secure area to detect the presence of an unauthorized intruder;

(c) selecting one or more of the immobilizing devices for deployment, in response to the detection of an unauthorized intruder; and

(d) deploying the selected immobilizing device by remote control, so as to propel the projectile toward the intruder and thus to at least temporarily incapacitate him/her. In this way, the intruder may be rendered harmless, at least until security personnel are able to take control of the intruder by conventional means, such as application of handcuffs or the like.

It is advantageous, in this regard, that the intruder be unaware that the immobilizing device has been installed or at least where it has been installed. In this way, the intruder would not attempt to avoid the effects of the immobilizing device or attempt to neutralize the device before the device is deployed. In particular, the invention contemplates that the immobilizing device, when installed, be concealed in the region of the secure area so as not to be visible to an unauthorized intruder.

In a preferred embodiment of the present invention, the immobilizing device propels a non-lethal projectile which delivers an immobilizing electric shock when it strikes a living creature. Such devices, wherein the electric shock energy is either stored in the projectile itself and delivered without wires, or delivered through wires which extend from the immobilizing device to the projectile, are well known.

One such device, known as a TASER® stun gun, is available commercially from TASER International, Inc. in Scottsdale, Ariz. 85260. The term TASER was coined by its inventor, Jack Cover, from the “Thomas A. Swift Electric Rifle” described in the book Tom Swift and His Electric Rifle by Victor Appleton. The TASER® stun gun is disclosed in numerous patents, including U.S. Pat. Nos. 4,254,132; 5,078,117 and 5,771,663, all of which are incorporated herein by reference.

A stun gun projectile which stores the electric shock energy to be delivered to a living target, and thus requires no wires, is described in the U.S. Pat. No. 5,962,806 to Coakley et al. which is also incorporated herein by reference.

In another preferred embodiment of the present invention, a non-lethal projectile delivers a tranquilizing, anesthetizing or at least an irritating chemical to the intruder. For example, the projectile may have the effect of a “poison dart”, delivering a snake poison or other immobilizing agent. In still another embodiment, the projectile itself may be a non-lethal liquid or gas which is irritating to the eyes and/or the nose and throat passages of the living target. Finally, a ballistic projectile may be made of resilient material, such as a “rubber bullet” which is non-lethal to its target.

In order to preserve the element of surprise, the immobilizing device must be triggered suddenly and swiftly when the unauthorized intruder enters the region of the secure area. Thus, it is important that the region of the secure area be monitored to detect the presence of the intruder and that the immobilizing device be triggered rapidly and without warning, after this presence has been detected. Advantageously, the region of the secure area may be monitored by a motion sensor, which detects any unauthorized movement in the monitored area, and/or by a static sensor which simply detects the presence of an unauthorized person or object. Sensors of this type are well known from building security systems, such as ADT Security Services in Boca Raton, Fla.

Alternatively, or in addition, the region of the secure area may be monitored by a video camera which transmits a video image for display at a remote location for visual inspection by security personnel. Also, or in addition, the region of the secure area may be monitored directly and visually by nearby security personnel.

Once the presence of an unauthorized intruder has been detected, the selected immobilizing device is deployed either automatically or through activation by security personnel. In one advantageous embodiment of the present invention, the security personnel effect the deployment of the selected immobilizing device by wireless remote control. Electronic transmitter and receiver devices suitable for such remote control are well known and are described, for example, in the U.S. Pat. No. 4,286,262 to Wahl and the U.S. Pat. No. 4,365,250 to Matsuoka et al., both of which are incorporated herein by reference. These patents describe a system which is suitable for controlling the opening and closing of a garage door; however, a system of this type, which functions to remotely operate an electric switch, can be used for any purpose. Alternatively, a hand held remote control device, having push buttons which are secured against inadvertent actuation by a cover or by other means, is used by security personnel to select and deploy the immobilizing device.

According to the present invention, a plurality of immobilizing devices are provided in the region of the secure area. One or more of these devices are then selected for deployment, either automatically or remotely by security personnel, in dependence upon the actual position of the unauthorized intruder. In this way, the chances of having the projectile strike the intruder are maximized and, in the case of a miss, a second, third, fourth (etc.) immobilizing device may be selected and deployed.

The system (method and apparatus) according to the invention can be utilized and deployed by persons who are minimally trained; that is, persons such as flight attendants on an aircraft who are not trained in dealing with highjackers, terrorists and the like. The system thus avoids the necessity of employing a trained flight marshal on board the aircraft.

The remote deployment of the system allows multiple intruders to be kept unaware of the controlling entity. As a result, the first as well as subsequent intruders can be incapacitated with minimum discovery, risk and potential harm to the person or persons who deploy the immobilizing devices. Further, the system allows deployment by persons who may not be of substantial physical stature, since it does not require physical contact between this person and the intruder.

Once immobilized, the “stun time” of the intruder allows others, such as passengers on an aircraft, to secure the intruder by means of handcuffs, etc. As such, the present invention thus eliminates the need for a flight marshal on board an aircraft.

These and other features and advantages will become apparent from the discussion that follows when taken in conjunction with the accompanying drawings.

### BRIEF DESCRIPTION OF THE DRAWINGS

FIG. 1 is a top, plan view of the region of an exemplary secure area, with a plurality of immobilizing devices installed in the adjacent walls in concealed fashion.

FIG. 2 is a front elevational view of the monitored area adjacent the secure area in the region shown in FIG. 1.

FIG. 3 is a side elevational view of the secure area and its adjacent monitored area in the region shown in FIG. 1.

FIG. 4 is a block diagram of an exemplary remote control system for controlling the deployment of immobilizing devices in the system of FIG. 1.

FIG. 5 is a perspective view of an exemplary remote control unit for controlling the deployment of immobilizing devices in the system of FIG. 1.

FIG. 6 is an exemplary cabin diagram of a Boeing 737-800 aircraft showing possible positions of a plurality of immobilizing devices and security personnel.

### DETAILED DESCRIPTION OF THE PREFERRED EMBODIMENTS

The preferred embodiments of the present invention will now be described with reference to FIGS. 1-6 of the drawings. Identical or similar elements in the various figures are identified with the same reference numerals.

FIG. 1 is a plan view showing a “secure area” 10, such as an operational area within a transport vehicle, a storage area within a building, or a staging area in an open arena. The secure area is surrounded on four sides by impassible walls or barriers 12, 14, 16 and 18. One of these walls 16 is provided with a door 19 leading to an “adjacent monitored area” 20.

The secure area 10 and the adjacent area 20 together form a “region”. As used herein, the term “region of the secure area” is intended to mean the secure area itself and any adjacent area through which an unauthorized intruder, who attempts to penetrate the secure area, must pass. This area may and should be monitored to detect the presence of an unauthorized intruder.

In the arrangement shown in FIG. 1, the adjacent monitored area 20 is delineated by the wall 16 on one side and two oppositely facing walls 22 and 24.

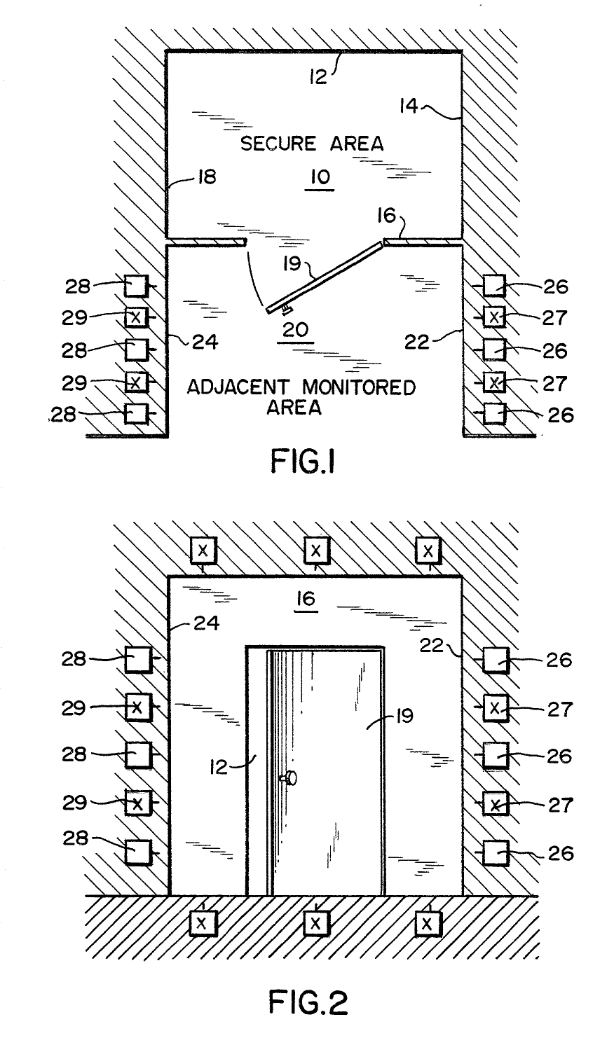

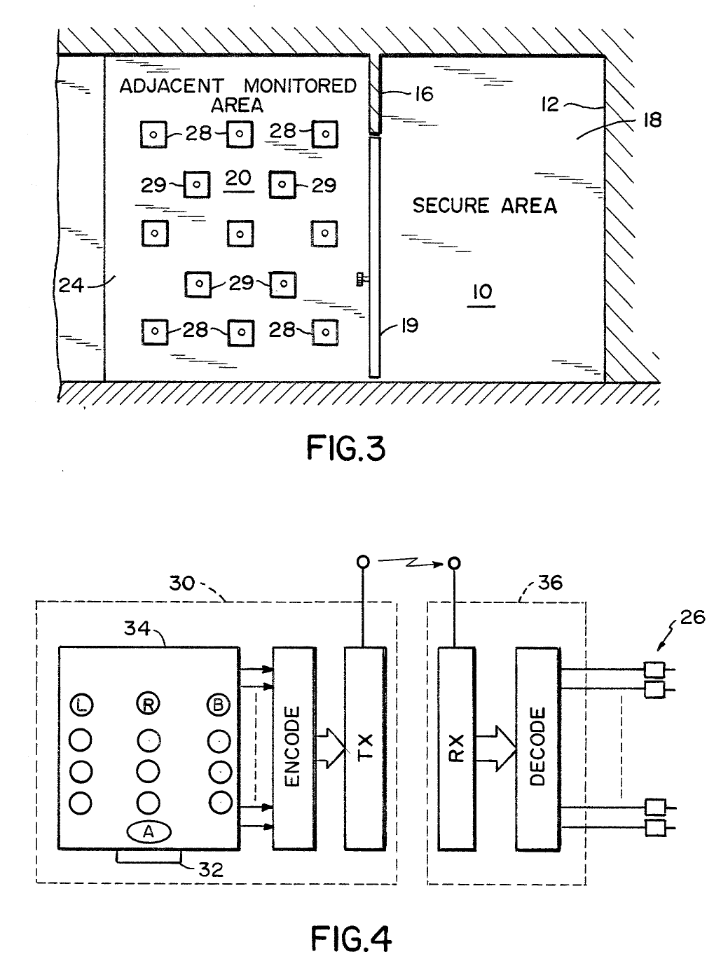

As may be seen in FIGS. 1 and 2, and also in FIG. 3, a matrix of TASER® guns 26 and 28 have been installed immediately behind the opposite walls 22 and 24, respectively, of the adjacent area 20. These “stun guns” are preferably arranged in concealed fashion so as not to be apparent to anyone, especially an unauthorized intruder. Even assuming that such an intruder were aware of the presence of the stun guns, however, it would be difficult for him/her to avoid their effects because of their multiplicity and placement. Concealment is therefore not an absolute requirement for the efficacy of the system.

If desired, additional lethal weapons 27 and 29, such as rigidly mounted, conventional (lethal) pistols, may be arranged adjacent to the plurality of stun guns 26 and 28—that is behind the walls 22 and 24, respectively. Stun guns and/or lethal guns may also be placed in the ceiling and floor as is illustrated in FIG. 2.

Because of the door 19 and the arrangement of the walls 22 and 24, an unauthorized intruder would have to pass through the adjacent area 20 when attempting to reach the secure area 10. Thus, while stun guns could be placed behind the walls 14 and 18 of the secure area, such stun guns would not be necessary and, in fact, should preferably be omitted to avoid the possibility of accidentally striking and immobilizing authorized personnel in the secure area.

As illustrated in FIG. 3, the stun guns in this example are arranged in a matrix with three horizontal rows—low, medium and high—with three stun guns disposed in each row. Lethal guns 29 may be placed within this matrix. The stun guns (and lethal guns, if present) are all aimed to propel their projectiles through the respective wall panel (that is, panel 22 or 24) towards the opposite wall panel (panel 24 or 22). Thus, the stun guns will be able to propel projectiles which will surely contact and immobilize an unauthorized intruder, no matter what the size and position of the intruder may be.

FIG. 4 is a block diagram of a transmitter/receiver device for triggering (deploying) selected ones of the stun guns in the embodiment of FIGS. 1-3. As is there shown, a transmitter device 30 is provided having a control panel with a number of buttons for use by security personnel. For safety sake, the transmitter requires that a separate “arming” button 32 be pressed at the same time as one or more selector buttons in order to deploy one or more of the stun guns. This arming button 32 is conveniently placed on one side of the control panel whereas the remaining buttons are oriented on the face of the panel.

Nine buttons 34, arranged in the same matrix orientation as the stun guns, are located on the face of the transmitter control panel with one button for each stun gun. Above these buttons are three buttons marked “R”. “L” and “B”. When the “R” button is pressed, the stun guns on the right wall 22 will be activated, and allowed to fire (deploy) upon pressing a button within the matrix; when the “L” button is pressed, the stun guns on the left wall 24 will be activated, and allowed to deploy when a matrix button is pressed. When the “B” button is pressed, the stun guns on both the right and the left wall are activated and will deploy simultaneously when a matrix button is pressed.

Finally, a large button marked “A” is provided at the bottom of the matrix. When pressed, together with the arming button 32, this large button “A” causes all the stun guns to fire together.

The signals from the various buttons are translated into a code which is transmitted on an RF carrier to a receiver unit 36. This receiver 36 demodulates the received signal to identify the code and then translates this code into individual firing signals for one or more of the respective TASER® stun guns 26.

The transmitter unit 30 is made small enough to fit conveniently into the pocket or coat jacket of security personnel in the region of the secure area. Such security personnel are advantageously in visual contact with the adjacent monitored area 20 and can control the firing of one or more of the stun guns.

FIG. 5 illustrates the appearance of an exemplary remote control device. Similar in many respects to a garage door opener, the device comprises an outer housing 37 with a plurality of buttons 38 arranged on the top surface. Instead of a separate “arming” button 32, the buttons may be protected against inadvertent actuation by means of a removable cap 39. When placed over the buttons, the cap prevents the buttons from being pressed.

In addition to actuation buttons which select and deploy the non-lethal immobilizing devices, the same or similar buttons may be used to select and deploy the lethal weapons, such as the weapons 27 and 29 shown in FIGS. 1-3.

Advantageously, the top surface of the housing 37 may depict a floor plan diagram of the monitored area—i.e., a pictograph—so that the user can easily recognize and select the correct button.

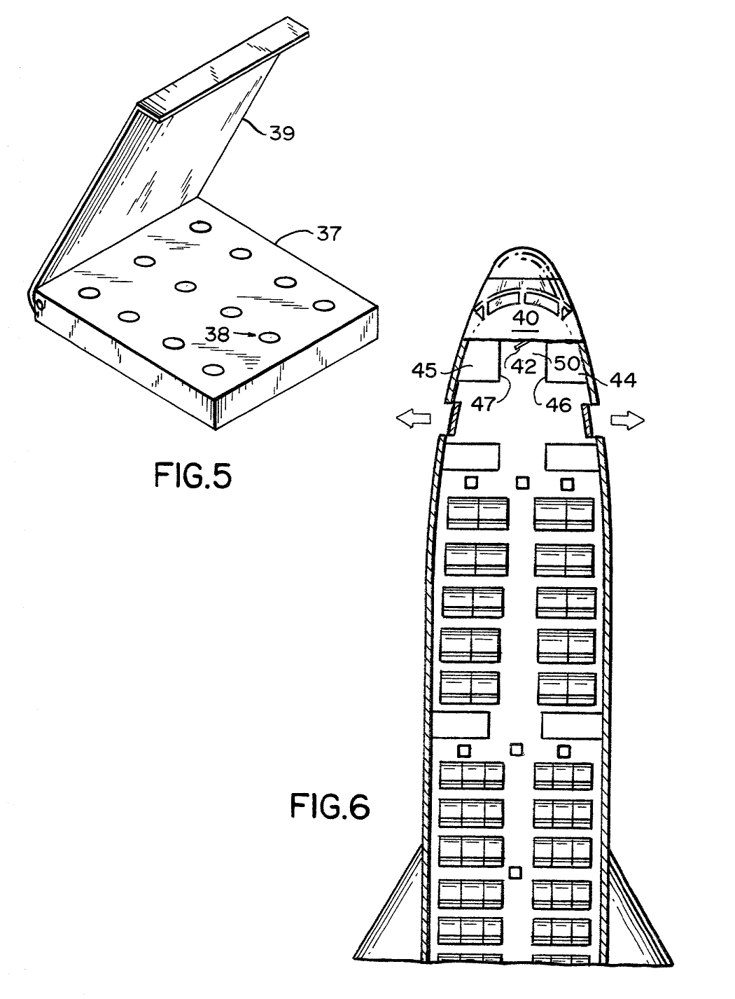

FIG. 6 illustrates a particular, practical application of the present invention in which the secure area is the cockpit 40 of a commercial, passenger aircraft that is accessible only by a single door 42. In this embodiment, the area 50 adjacent the door 42 is bounded on both sides by a galley 44 and lavatory 45 having facing walls 46 and 47, respectively. A plurality of stun guns are disposed behind the walls 46 and 47, in the matrix orientation, in the manner illustrated in FIGS. 1-3, and aimed in the direction of the adjacent area 50.

It will be understood that other types of vehicles, such as boats, trains, trucks and motor coaches, have a similar floor plan arrangement and can be secured in a similar manner.

As may be seen, any unauthorized intruder(s) who attempt(s) to reach the flight deck or cockpit 40 must pass through the monitored area 50 between the opposing walls 46 and 47 and attempt to open the cockpit door 42. When this occurs, the intruder(s) would be in full view of at least one of a plurality of security personal (flight attendants, flight marshal's, etc.) standing nearby or in passenger seats that afford a view of the area 50. These security personnel, each of whom would possess a remote control unit of the type shown in FIGS. 4 and 5, would deploy one or more of the stun guns so that the intruder(s) would be at least temporarily immobilized. Thereafter, the security personnel (or others) would be able to subdue, overpower and handcuff the intruder(s) and otherwise take control of the situation.

One great advantage of the present invention is that the TASER® guns need not propel their projectiles with such force as to pose a danger of penetrating the wall of the fuselage and creating an air hole, that may lead to a sudden decompression of the aircraft cabin, or that they may kill or seriously injure an innocent bystander. Even if an innocent person happened to be, or was forced to be, in the area 50 adjacent the cockpit, such person would only be temporarily immobilized if hit by a projectile from a TASER® gun. Accordingly, “collateral damage,” to the aircraft, leading to a catastrophic event, or to innocent persons is minimized.

In conclusion, the present invention may advantageously be used in connection with any potentially explosive, sterile or other environments wherein collateral damage, caused by a lethal weapon, would be disadvantageous or even catastrophic.

There has thus been shown and described a novel method and apparatus for immobilizing an unauthorized intruder to a secure area which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method of immobilizing an unauthorized intruder to a secure area, wherein a plurality of immobilizing devices, each capable of propelling a projectile through space, are arranged in the region of the secure area and aimed to direct the projectiles toward a plurality of points where an intruder is likely to pass when attempting to reach the secure area, said method comprising the steps of:
(a) monitoring the region of the secure area to detect the presence of an unauthorized intruder;
(b) detecting the presence of an unauthorized intruder in the region of the secure area;
(c) selecting one of the plurality of immobilizing devices which is likely to be effective in incapacitating the intruder when deployed; and
(d) deploying said one immobilizing device, in response to the detection and selection steps, so as to propel a projectile toward the intruder and thus to at least temporarily incapacitate the intruder,
whereby the intruder is rendered harmless for a period of time, at least until security personnel are able to take control of the intruder.

2. The method defined in claim 1, wherein said plurality of immobilizing devices are each aimed at a different point in the region of the secure area.

3. The method defined in claim 1, wherein the immobilizing devices are concealed from view in the region the secure area, such that the immobilizing devices are not apparent to an unauthorized intruder.

4. The method defined in claim 1, wherein the projectile delivers non-lethal electric shock energy when it strikes a living creature.

5. The method defined in claim 4, wherein the electric shock energy is delivered through at least one wire which extends from the immobilizing device to the projectile.

6. The method defined in claim 5, wherein said immobilizing device is a TASER® stun gun.

7. The method defined in claim 4, wherein the electric shock energy is stored in the projectile and delivered without wires.

8. The method defined in claim 1, wherein the projectile delivers an immobilizing non-lethal element when it strikes a living creature.

9. The method defined in claim 8, wherein said non-lethal element is selected from the group consisting of an anesthetizing agent and a non-lethal ballistic projectile.

10. The method defined in claim 1, wherein the projectile is lethal when it strikes a living creature.

11. The method defined in claim 1, wherein the region of the secure area is monitored by a motion sensor.

12. The method defined in claim 1, wherein the region of the secure area is monitored by a static sensor.

13. The method defined in claim 1, wherein the region of the secure area is monitored by a video camera.

14. The method defined in claim 1, wherein the region of the secure area is monitored visually by security personnel.

15. The method defined in claim 14. wherein the security personnel select and deploy said one immobilizing device.

16. The method defined in claim 14, wherein the region of the secure area is monitored visually by security personnel, and wherein said security personnel select the immobilizing device to be deployed and deploy the selected device.

17. The method defined in claim 16, wherein said security personnel deploy the selected immobilizing device by a wireless remote control device.

18. The method defined in claim 1, wherein the region of the secure area is monitored by at least one of a motion sensor and a static sensor, and wherein said one immobilizing device is selected and deployed automatically in response to the presence of the intruder the region of the secure area.

19. The method defined in claim 1, wherein the secure area is in a building.

20. The method defined in claim 1, wherein the secure area is in an open area, outside a building.

21. The method defined in claim 1, wherein the secure area is in a transport vehicle.

22. The method defined in claim 21, wherein the vehicle is selected from the group consisting of an aircraft, a boat, a train, a truck and a motor coach.

23. Apparatus for immobilizing an unauthorized intruder to a secure area, comprising, in combination:
(a) a plurality of immobilizing devices, each capable of propelling a projectile through space, arranged in a region of the secure area and aimed to direct the projectiles toward a plurality of points where an intruder is likely to pass when attempting to reach the secure area; and
(b) means for selecting and deploying one of the immobilizing devices, upon detecting the presence of an intruder in said region of the secure area, so as to propel a projectile toward the position where the intruder is likely to be and thus to at least temporarily incapacitate the intruder,
whereby the intruder is rendered harmless for a period of time, at least until security personnel are able to take control of the intruder.

24. The apparatus defined in claim 23, wherein said plurality of immobilizing devices are each aimed at a different point in the region of the secure area.

25. The apparatus defined in claim 23, wherein the immobilizing devices are concealed from view in the region of the secure area, such that the immobilizing devices are not apparent to an unauthorized intruder.

26. The apparatus defined in claim 23, wherein the projectile delivers non-lethal electric shock energy when it strikes a living creature.

27. The apparatus defined in claim 26, wherein the electric shock energy is delivered through at least one wire which extends from the immobilizing device to the projectile.

28. The apparatus defined in claim 27, wherein said immobilizing device is a TASER® stun gun.

29. The apparatus defined in claim 26, wherein the electric shock energy is stored in the projectile and delivered without wires.

30. The apparatus defined in claim 23, wherein the projectile delivers an immobilizing non-lethal element when it strikes a living creature.

31. The apparatus defined in claim 23, wherein the non-lethal element is selected from the group consisting of an anesthetizing agent and a non-lethal ballistic projectile.

32. The apparatus defined in claim 23, wherein the projectile is lethal when it strikes a living creature.

33. The apparatus defined in claim 23, further comprising at least one motion sensor for monitoring the region of the secure area and detecting the presence of an unauthorized intruder.

34. The apparatus defined in claim 23, further comprising at least one static sensor for monitoring the region of the secure area and detecting the presence of an unauthorized intruder.

35. The apparatus defined in claim 23, further comprising at least video camera for monitoring the region of the secure area for the presence of an unauthorized intruder.

36. The apparatus defined in claim 23, wherein the region of the secure area is monitored by visually by security personnel, and wherein said security personnel select the immobilizing device to be deployed and deploy the selected device.

37. The apparatus defined in claim 36, further comprising a wireless remote control device for deploying selected ones on said immobilizing devices and wherein said security personnel select and deploy the immobilizing device by means of said remote control device.

38. The apparatus defined in claim 23, further comprising at least one of a motion sensor and a static sensor for monitoring the region of the secure area and detecting the presence of an unauthorized intruder, and means for selecting and deploying an immobilizing device automatically in response to the presence of the intruder the region of the secure area.

39. The apparatus defined in claim 23, wherein the secure area is in a building.

40. The apparatus defined in claim 23, wherein the secure area is in an open area, outside a building.

41. The apparatus defined in claim 23, wherein the secure area is in a transport vehicle.

42. The apparatus defined in claim 41, wherein the vehicle is selected from the group consisting of an aircraft, a boat, a train, a truck and a motor coach.
